(19) United States
(12) Patent Application Publication
(10) Pub. No.: US 2022/0398287 A1
(43) Pub. Date: Dec. 15, 2022

(54) Map Based Internet Browsing

(71) Applicants: Dirk Ockhardt, Wahpeton, ND (US); David Stier, Essen (DE); Jan Quednau, Dortmund (DE)

(72) Inventors: Dirk Ockhardt, Wahpeton, ND (US); David Stier, Essen (DE); Jan Quednau, Dortmund (DE)

(21) Appl. No.: 17/343,957

(22) Filed: Jun. 10, 2021

(51) Int. Cl. G06F 16/954; G06F 16/29; G01C 21/36; G06Q 50/16

(52) U.S. Cl. CPC G06F 16/954; G06F 16/29; G01C 21/3614; G06Q 50/16

(57) ABSTRACT

A map based internet browsing method and map based internet browsing system which allows a user to access a map interface on a client computer such that the user can find information on the internet in a map format rather than a keyword format. The map based internet browsing method and system allows for a user to select a map mode which causes one or more widget to activate and to display content about a subject matter. Available widgets may be activated by the user to display content on the map interface and may be used by the user to filter, sort, or search content. Time stamps on content may be used to determine what content is displayed. Developers may login to a developer portal for the purpose of developing or creating new widgets.

### FIELD OF TECHNOLOGY

This disclosure relates generally to technology for browsing content on an internet-based map, more particularly, to a method and system of utilizing data sources to display content on a map interface.

### BACKGROUND

Internet users traditionally find information on the internet by using a search engine which executes a search based on input data to retrieve stored data. Search engines are often configured to function using keyword based search and retrieval methods. The user may select search filters and user preferences to customize the results. Search engines can also be configured to present results based on the user's browsing history and other information collected about the user. Commonly, search engines use server-side algorithms to show results in a certain order and manner based on numerous factors.

Search engines may be configured to display results on a map interface. The results on a map are displayed based on input data, filters, and server-side algorithms. A user may use filters such as showing restaurants or a certain type of restaurant on the map interface. Maps may be displayed to the user based on geographic region. The input data which the user searches with typically may include a geographic region and keyword.

### SUMMARY

This disclosure is directed toward a map browsing method and system used by a user on a map interface that may employ a map mode, a widget, and a time stamp filter. Users may select a mode to display a certain type of subject matter on the map interface. Map modes may include subject matter such as real estate, lifestyle, services, and so forth. A map mode sets a preselected widget group for the map interface. The user may select widgets to get additional content. A widget may have filtering, sorting, and searching functions for content which is caused to be displayed by the widget. The user may use a time stamp to filter, sort, or search what is displayed on the map interface based on a selected time.

A map mode may be selected by a user. When a map mode is selected, a widget group comprising of various widgets relating to a subject matter are activated. The activated widgets cause content to be displayed on the map interface in accordance with each widget's respective widget programing. The user may activate other widgets, deactivate activated widgets, or may use activated widgets to filter, sort, or search content which is displayed by the respective widget. Widgets may use a time stamp on an item of content to determine whether such content is displayed on the map interface. A user may select a different map mode. Effectively, this method and system allows for a user to layer content from multiple data sources from different databases onto a map interface. Known map browsing methods and systems are incapable of similar function or are not as functional and efficient for use.

An exemplary map mode might be winter activities. The selection of the winter activities map mode may cause a skiing widget, a snowmobiling widget, a trails widget, an outdoor company widget, and other relevant widgets to activate. Each of the widgets in the example may have a different data source and may be developed by different developers. For example, the outdoor company widget may have been developed by an outdoor company for marketing purposes. A user in this example, would have the ability to view a unique map interface with content displayed on the map from the various widgets activated.

Each type of information which is shown on the map may be categorized by subject matter, geographic location, time, and other relevant information. This disclosed method and system of browsing the internet allows the user to find information on the internet by browsing in a visual map interface using a mode, a widget, and time rather than using the traditional keyword based search engine methods.

### BRIEF DESCRIPTION OF THE DRAWINGS

These and other features and advantages of the present invention will become more readily appreciated as the same becomes better understood by reference to the following detailed description when considered in connection with accompanying drawings, wherein:

FIG. 1 is a simplified block diagram showing the relation between elements of the internet;

FIG. 2 is a simplified block diagram showing how a user may access the disclosed map browsing method;

FIG. 3 is a simplified block diagram showing various map modes;

FIG. 4 is a simplified block diagram showing how map modes and widgets control map interface content;

FIG. 5 is a simplified block diagram showing the elements of content;

FIG. 6 is a simplified block diagram showing the various types of content;

FIG. 7 is a simplified block diagram showing the database levels which may comprise content;

FIG. 8a is a simplified block diagram showing how a user may be routed to a particularly configured map interface;

FIG. 8b is a simplified block diagram showing how a user may begin browsing an unconfigured map interface;

FIG. 9 is a simplified block diagram showing how a user may use a map mode or a widget to browse a map interface;

FIG. 10 is a simplified block diagram showing how content is compiled for display on the map interface;

FIG. 11 is a simplified block diagram showing the functionality of a widget;

FIG. 12 is a simplified block diagram showing how a user may activate and use a widget;

FIG. 13 is a simplified block diagram showing who commonly may develop widgets;

FIG. 14 is a simplified block diagram showing how widgets are developed;

FIG. 15 is a simplified block diagram showing the elements of a widget;

FIG. 16 is a simplified block diagram showing various subjects which may be displayed as content;

FIG. 17 shows an exemplary map interface wherein content is shown on the map interface based on the map mode selected;

FIG. 18 shows an exemplary map interface wherein content is shown on the map interface based on the widget activated;

FIG. 19 shows an exemplary map interface wherein a user has selected an item of content which is configured to view limited content information;

FIG. 20 shows an exemplary map interface wherein a user has selected an item of content which is configured to view content information.

### DETAILED DESCRIPTION OF THE ILLUSTRATED EMBODIMENTS

### General

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

### Figures Detail

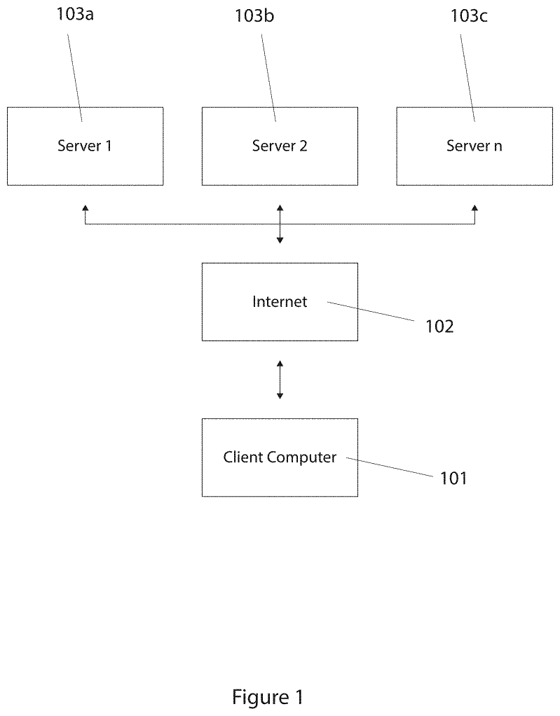

FIG. 1 is a simplified block diagram showing the relation between elements of the internet. FIG. 1 represents a client-server system that may be used to implement the map browsing method. The client-server system may include a client computer 101, a computer network 102, and one or more servers 103a, 103b, and 103c (collectively servers 103). The client computer 101 may include but is not limited to a personal computer 202, smartphone 203, tablet 204, or any other internet-enabled device 205. To perform the disclosed method the user 201 is using the client computer. The computer network 102 may be a local area network, a wide area network, the internet, or any other type of network. The servers 103 and client computer 101 are both connected to the computer network 102. The client computer 101 is the device on which a user 201 may access a map interface 401.

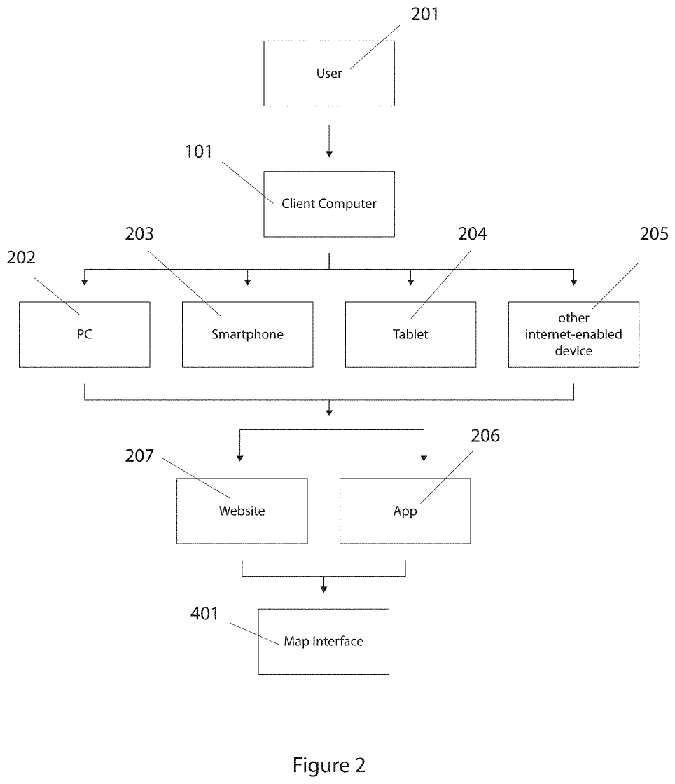

FIG. 2 is a simplified block diagram showing how a user 201 may access the disclosed map browsing method. A user 201 uses a client computer 101 which may include but is not limited to a personal computer 202, a smartphone 203, a tablet 204, or any other internet-enabled device 205. The client computer 101 is used to access the map interface 401 on either an app 206 or a website 207. An app 206 is typically understood to be a type of software installed and used on the client computer 101. A website 207 is understood to be one or more web pages accessed on a web browser that is capable of accessing the internet.

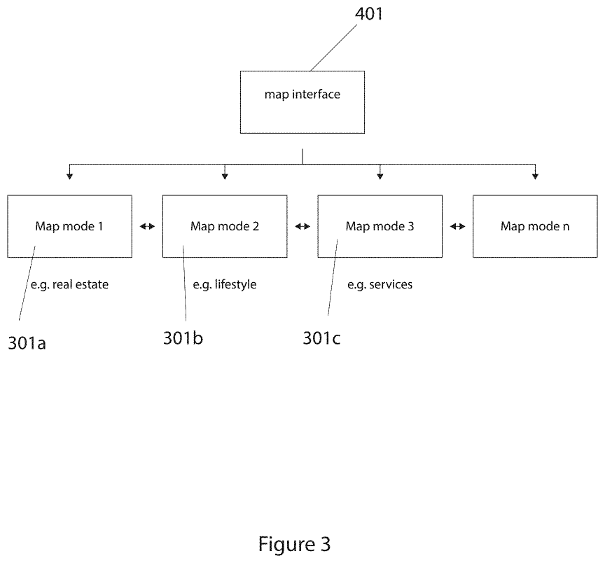

FIG. 3 is a simplified block diagram showing various map modes. A map interface 401 for the disclosure map browsing method, can be switched between different map modes 301. Map modes 301 (as referenced collectively or individually a map mode) represent various subject matters 1601. A subject 503 is a group of one or more widgets 403. The widgets 403 which comprise a subject 503 are typically related to a subject matter 1601. When a map mode 301 is selected, the widgets 403 comprising a subject 503 are activated. The widgets comprising a subject 503 are a widget group. For example, a map mode might be a real estate map mode 301a, a lifestyle map mode 301b, a service map mode 301c, or any other subject matter. When a particular map mode 301 is selected, the map interface 401 displays content 501 which is programed to be displayed based on the widget group defined by the map mode 301 selected. For example, if a real estate map mode 301a is selected, the map interface 401 may display content 501 such as real estate properties and related information due to the activation of one or more widgets 403. Map modes 301 may be customized to activate any widget group. The disclosed method requires the map interface 401 to be displaying described content 501.

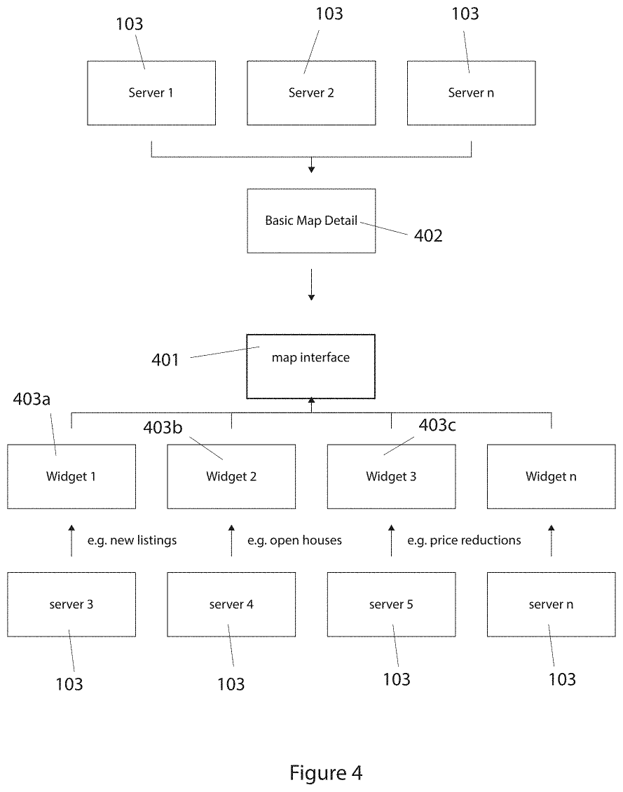

FIG. 4 is a simplified block diagram showing how map modes 301 and widgets 403 may control map interface 401 content 501. Servers 103 store content 501 which can be displayed on the map interface 401. Base map detail 402 is displayed on the map interface 401 by default. Base map detail 402 includes geographic shapes, land masses, roads, water bodies, and other basic information appreciated by one of ordinary skill in the art. In FIG. 4 the base map detail 402 is being provided by the servers 103. Content 501 is dynamically placed on the map interface 401 by activated widgets 403. Widgets 403 are configured to display content 501 on the map interface 401 but may also be configured to provide for filtering, sorting, or searching of content 501 which is from the data sources 1404 used by the respective widget. In such configurations, widgets 403 are using data for the content 501 from one or more servers 103.

In an example where a real estate map mode 301a is selected, an exemplary set of widgets 403 may be activated by the user 201. Such exemplary widgets 403 may include but are not limited to a new listing widget 403a, an open house widget 403b, and a price reduction widget 403c. When a user 201 is using the map interface 401 for the purpose of browsing real estate, being able to use widgets 403 to filter, sort, or search 902 content 501 related to new listings, open houses, or price reductions is a valuable capability.

Another example of a map mode 301 may be winter sports. When a user 201 selects the map mode 301 winter sports, certain widgets 403 related to the subject matter 1601 winter sports are activated as programed by a developer. The widgets 403 which are activated in this example comprise the subject 503 of the map mode 301. The widgets comprising a subject 503 are a widget group. In this example widgets 403 that comprise the subject 503 may include a skiing widget, a slopes widget, a lift destination widget, a cross country skiing widget, and so forth. The user 201 may further activate other widgets 403 or deactivate activated widgets 403 to cause the map interface 401 to display the desired content 501. Map modes 301 may be programed to comprise a different widget group based on the time of the day, season, or other such appreciated metrics.

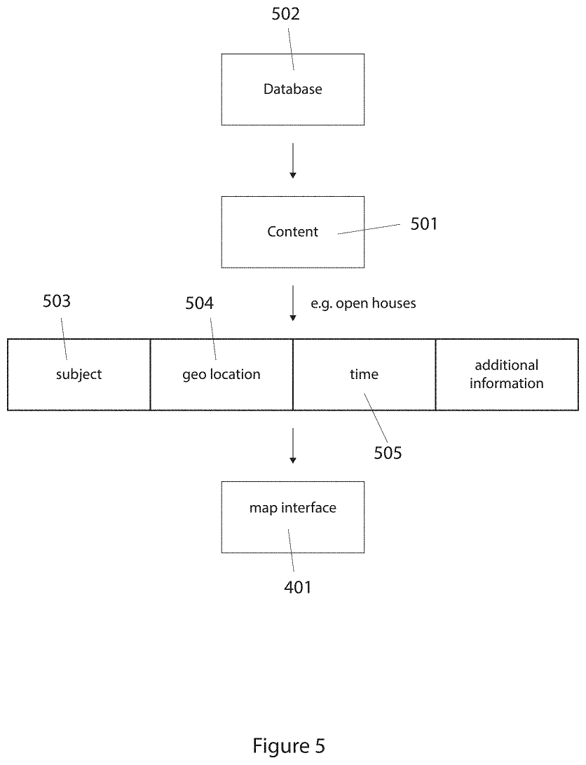

FIG. 5 is a simplified block diagram showing the elements of an item of content 501. Content 501 may be provided to the map interface 401 from servers 103. Content 501 provided by servers 103 is often stored within a database 502 located on one or more servers 103. Each item of content 501 may include a subject 503, a geo location 504, a time stamp 505, and any relevant additional information. In the event an item of content 501 lacks a subject 503, geo location 504, or time stamp 505 a default value may be provided. Map modes 301 cause content 501 to be displayed based on the activated widgets 403 in the widget group and their respective widget programing 907. The geo location 504 is the piece of data information that determines where upon the map interface 401 the item of content 501 will be displayed. The time stamp 505 may be used by widgets 403 to determine whether an item of content 501 will be displayed on the map interface 401.

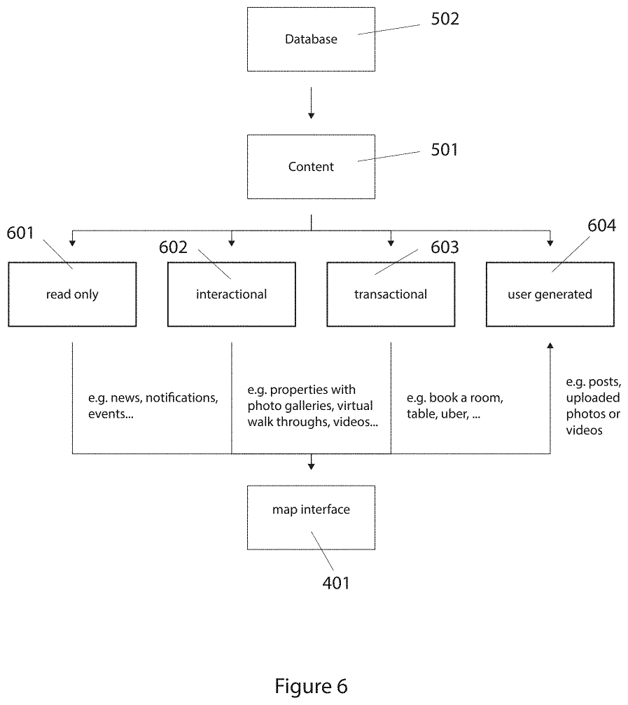

FIG. 6 is a simplified block diagram showing the various types of content 501. Content 501 may come in a variety of formats including but not limited to read only 601, interactional 602, transactional 603, or user generated 604. The various content 501 formats may be provided to the map interface 401. Examples of read only 601 content include but are not limited to news publications, notifications, or event descriptions. Examples of interactional 602 content include but are not limited to galleries, virtual walk throughs, videos, and other similar items. Examples of transactional 603 content include but are not limited to booking a reservation, ordering a car, or ordering food. Examples of user generated 604 content include but are not limited to posting information, uploading files, taking videos, or taking photos. All of these formats of content may be displayed on the map interface 401. Subject 503, geo location 504, time stamp 505, and other factors may be used by widgets 403 to determine what content 501 is displayed on the map interface 401.

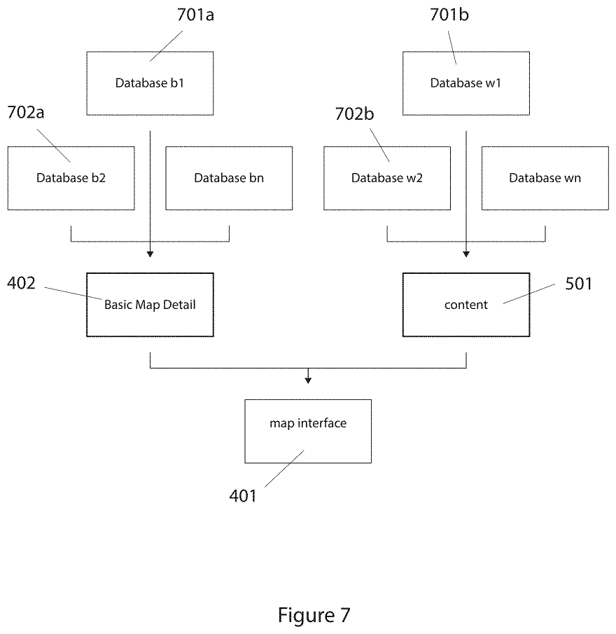

FIG. 7 is a simplified block diagram showing the database levels which may comprise the database in which content 501 is stored. Content 501 is typically stored within one or more databases 502 which are on servers 103. Content 501 may be stored in a variety of database 502 types. In some embodiments the map browsing method and system will employ the use of three different types of a database 502.

A first level database 701a may be employed for base map detail 402. Widgets 403 may use a first level database 701b. The first level databases 701 (referenced collectively) are databases wherein the servers 103 providing the content 501 are controlled by the host. The host is the server or servers which are providing map browsing method software and system. A second level database 702a may also be used for base map detail 402. Widgets 403 may use a second level database 702b for content 501. The second level databases 702 (referenced collectively) are databases wherein the content 501 is pulled from servers 103 outside the control of the host. A third level database for base map detail 402. Widgets 403 may use a third level database for content 501. The third level databases (referenced collectively) are databases wherein the content 501 is pushed to the map interface 401 from third party providers. An example of a third level database is one wherein a rideshare company pushes vehicle locations to the map interface 401. In such example, the rideshare company may have a customized widget 403 which provides the content 501 to the map interface 401.

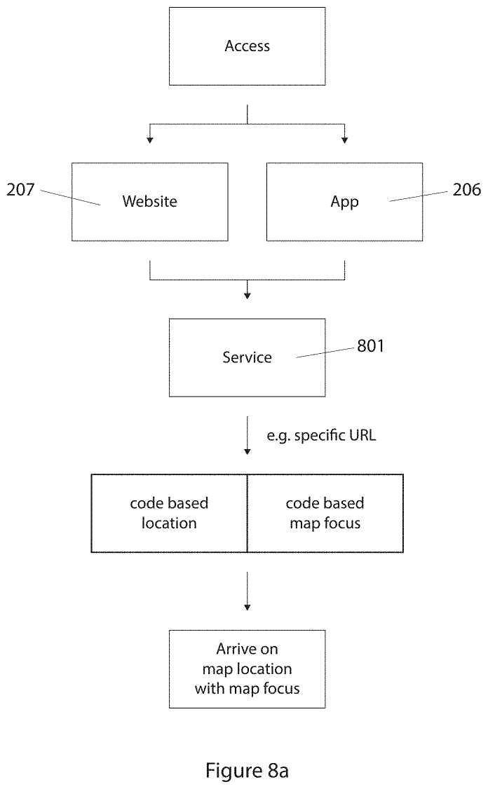

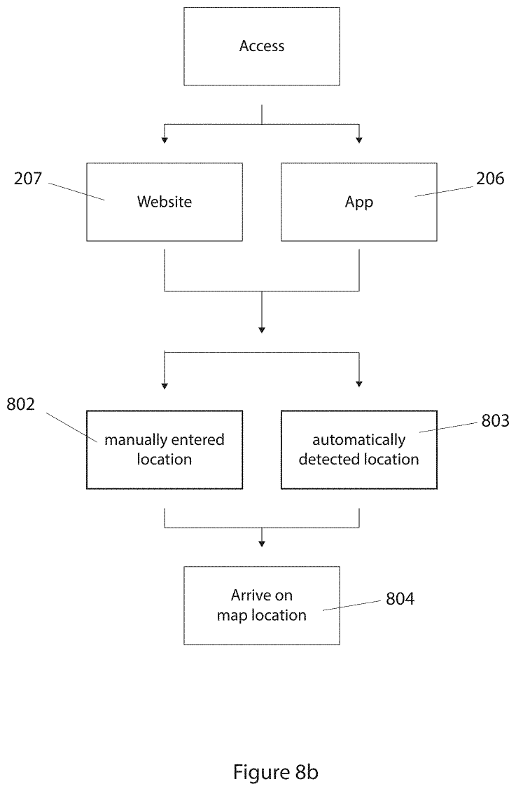

FIG. 8a is a simplified block diagram showing how a user may be routed to a particularly configured map interface 401. When a user 201 accesses the map interface 401 via a website 207 or an app 206, a user 201 can be directed to the map with a code based workflow. A code based workflow is one where a user 201 begins using the map interface 401 on specific coded directions. An example of such code based workflow is one where the user 201 is using a web browser on a third party site such as a real estate broker's webpage and the user is redirected to the map interface 401 by the third party site. This third party site may be a service 801 which provides the code based workflow. The service 801 may provide a link which directs the user 201 to the map interface 401 in such a way that the map interface 401 displays the map mode 301, widgets 403, and map interface 401 in such a way that is directed by the service 801. For example, the service 801 may direct the user 201 to a specific geographic location on the map interface 401. In another example, the service 801 may provide a button which the user 201 may press which results in a specific map mode and a specific widget group selected.

FIG. 8b is a simplified block diagram showing how a user 201 may begin browsing an unconfigured map interface 401. In this particular embodiment the user 201 would typically access the map interface 401 without going through a service 801. This effectively means the user 201 is accessing the map interface 401 without any service 801 providing a configuration. In one example, a user 201 may use a web browser to access the map interface 401 by entering a url address which provides such access. When the user 201 enters the url address, the map interface 401 may be configured to display a geographic location based on the user's location or another desired location. The user 201 may be automatically located 803 by using the user's IP address or any other method understood by a person with ordinary skill in the art. Alternatively, the user 201 may manually enter 802 a desired geographic location at which the user 201 desires to display content 501. Once the desired geographic location is identified, the map interface 401 will display the map location 804.

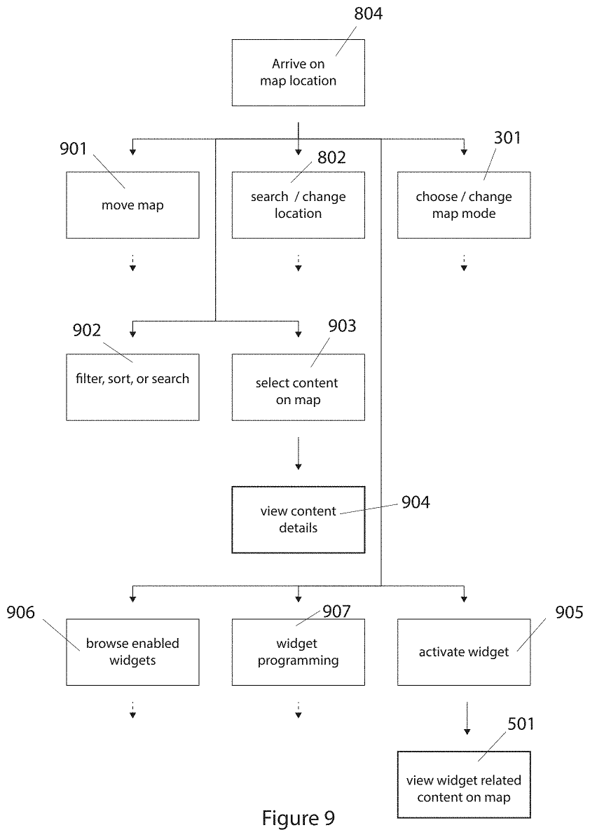

FIG. 9 is a simplified block diagram showing how a user may use a map mode 301 or a widget 403 to browse a map interface 401. When a user 201 is displayed a desired map location 804, the user 201 may further configure the map by inputting a variety of commands. The user 201 may move 901 the map location 804 by panning, zooming, scrolling, or any other function understood in the art. The user 201 may manually enter 802 a new location. The user 201 may select a map mode 301 or change the map mode 301 by selecting a different map mode 301. The user 201 may filter, sort, or search 902 content 501 used by a widget 403 as allowed by each respective widget programing 907. Map modes 301 are used to determine which widget groups are activated at the map location 804. Widgets 403 may be used to filter, sort, or search 902 their respective used content 501 in a variety of methods. At any point a user 201 may click 903 content 501 on the map interface 401 for the purpose to view content information 904. Not all items of content 501 are clickable for the purpose to view content information 904. An example of an item of content 501 which may be clicked to view content information 904 is a restaurant.

At any point, a user 201 can activate 905 widgets 403 or alternatively deactivate 1101 widgets 403. Once activated, the user 201 may view the widget 403 related content 501 on the map interface 401. The user 201 may browse 906 enabled widgets. The user 201 may use widget programing 907 to filter, sort, or search 902 content 501. Widget programing 907 is programed by a developer 1401. A user 201 activating a widget 403 is a function of the disclosed method. Widget programing 907 is coding which is developed by a developer 1401 when the developer 1401 is creating or modifying a widget 403. Custom coding may include coding languages such as but not limited to PHP, C#, Java, and other languages understood by a person with ordinary skill in the art. Custom coding may be used by the developer 1401 to program how a widget 403 allows for filtering, sorting, or searching to be performed by a user 201 and may be used by the developer 1401 to program what content 501 will be displayed on the map interface 401 by the activation of the widget 403.

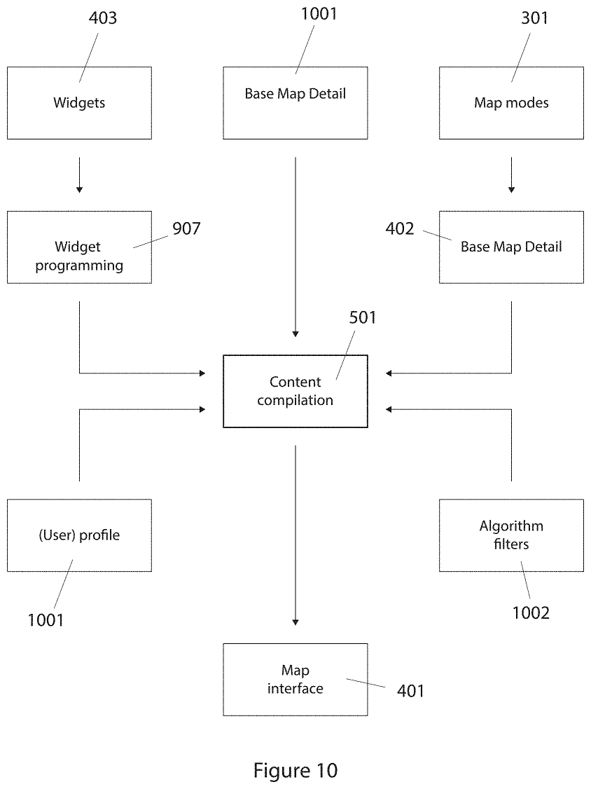

FIG. 10 is a simplified block diagram showing how content is compiled for display on the map interface 401. Content 501 is compiled on the map interface 401 using base map detail 402, map modes 301, widgets 403, algorithms 1002, and a user profile 1001. Widgets 403 may be configured to modify if and how base map detail 402 is displayed. Map modes 301 also may be configured to control the display of base map detail 402 by way of activating or deactivating certain widgets 403. Widgets 403 may also be configured to control the map interface 401 display by using widget programing 907. Algorithms 1002 are understood to be any search algorithm appreciated by a person of ordinary skill in the art for the purpose of determining what content 501 to display.

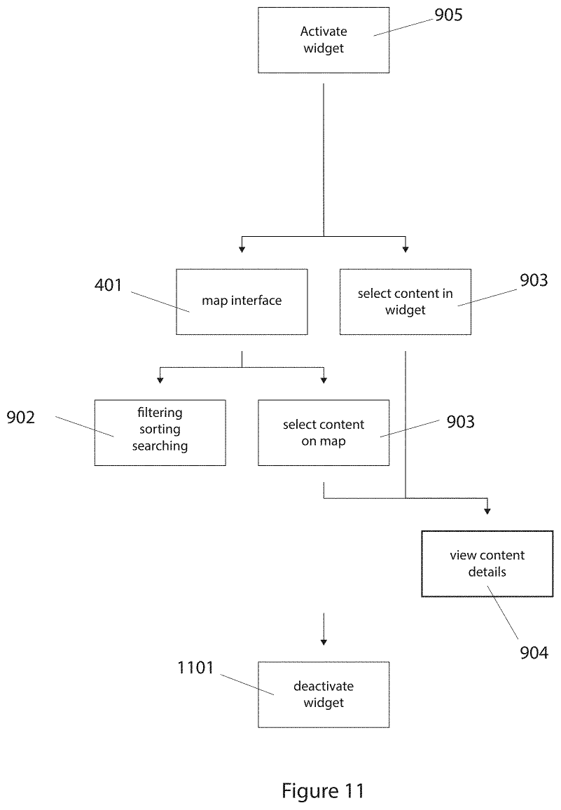

FIG. 11 is a simplified block diagram showing the functionality of a widget 403. A user 201 may activate 905 a widget 403 at any point. When the user 201 activates a widget 403, the widget 403 may cause content 501 to be displayed on the map interface 401. When the user 201 makes an input to activate 905 a widget 403, the user 201 may also use the widget 403 to filter, sort, or search 902 content 501 on the map interface 401 as defined by the widget programing 907. The widget programing 907 may be used to filter, sort, or search 902 content 501. Generally, the content 501 which may be filtered, sorted, or searched is content 501 displayed on the map interface 401 due to the activation of a widget 403. A user 201 may use any of the available filter, sort, or search 902 functions to display desired content 501. A user 201 can click 903 an item of content 501 on the map interface 401. Alternatively, a widget 403 may be configured to allow the user 201 to click 903 an item of content 501 within the widget 403. When the user 201 clicks 903 an item of content 501, the user 201 may view content information 904.

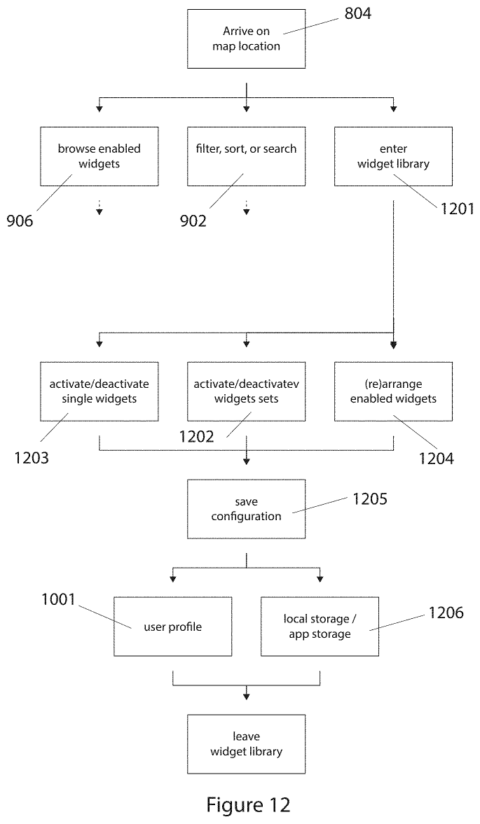

FIG. 12 is a simplified block diagram showing how a user 201 may activate 905 and use a widget 403. When a user 201 arrives on a map location 804 a user 201 has a variety of options available for widget 403 use. As explained, the user 201 may activate 905, browse 906, or use widget 403 filter, sort, or search 902 functions. The user 201 may enter a widget library 1201 and view alternative widgets 403. The user 201 entering the widget library 1201 and viewing widgets 403 is a function of the disclosed method. Widgets 403 can be activated or deactivated as a set 1202 or individually 1203. Widgets 403 may be given an arrangement 1204 by the user 201. Configurations 1205 (or individually a configuration) may be saved for future use. Configurations 1205 are the combination of the selected map mode 301, activated widgets 403, and widget arrangement 1204. Configurations 1205 may be saved on local storage 1206 of the client computer 101. Alternatively, configurations 1205 may be stored on a user profile 1001. A user 201 may leave 1207 a widget library 1201. Saving the configurations 1205 is a function of the disclosed method.

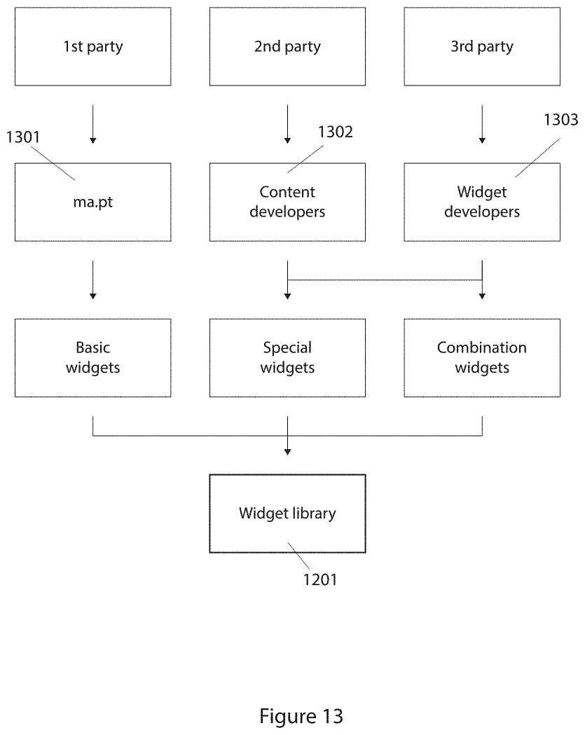

FIG. 13 is a simplified block diagram showing who commonly may develop widgets 403. Generally, it is expected that three different groups will develop widgets 403. The host 1301 may develop widgets 403. Content developers 1302 are generally third-party groups who develop a widget 403 for the purpose of providing their content 501 for use on the map interface 401. Widget developers 1303 are generally third-party groups who combine data sets or widgets 403 into new widgets 403. All such widgets 403 may be placed for use by a user 201 in the widget library 1201.

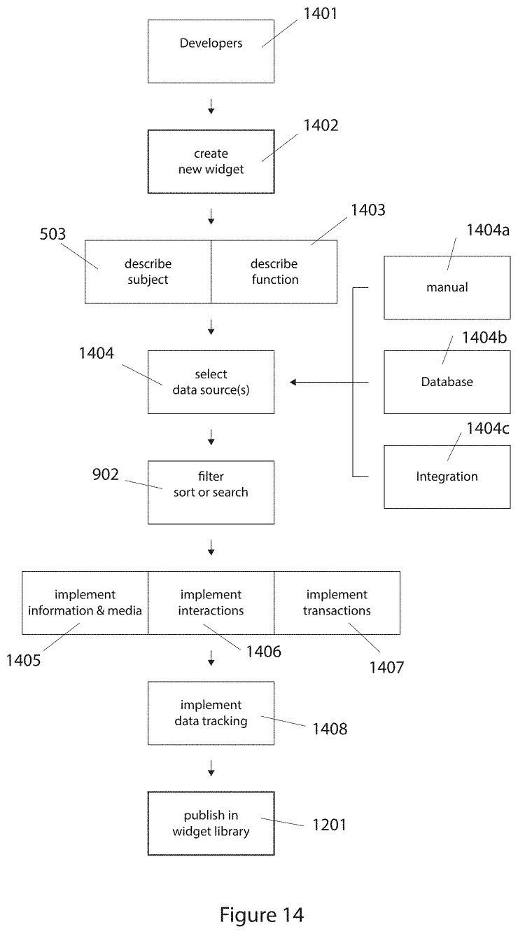

FIG. 14 is a simplified block diagram showing how widgets 403 are developed. Widget developers 1303, content developers 1302, and the host 1301 all comprise potential developers 1401, though any party may be a developer 1401. Developers 1401 are anyone who creates or develops a new widget 403. A developer 1401 can login to a developer portal 1402 for creating a widget 403. The developer 1401 must describe the content 501 and function 1403 of the widget 403. The developer 1401 must select the data sources 1404 which are to be used by the widget 403 for its widget programing 907. Data sources 1404 may include manual data entry 1404a, databases 1404b, data integrations 1404c (collectively data sources 1404), and any other source understood and appreciated by one with ordinary skill in the art. The developer 1401 must define the filter, sort, or search 902 functions available to the user 201. The developer 1401 may configure the widget 403 to provide custom information and media 1405, interactions 1406, transactions 1407, and may collect data 1408 on user 201 activity. An example of a transaction 1407 may be allowing the user 201 to order a good or service from the map interface 401 using a widget 403. Widgets 403 may be displayed in the widget library 1201.

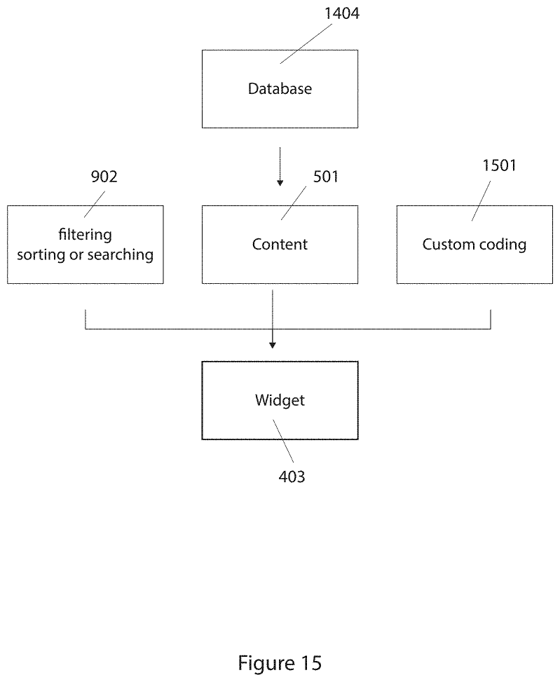

FIG. 15 is a simplified block diagram showing the elements of a widget 403. A widget 403 generally is comprised of a few structural features. A widget 403 has a filter, sort, or search 902 function, a content function, and a custom coding 1501 function. The filter, sort, or search 902 function allows a user 201 to customize what content 501 is displayed on the map interface 401. The content function allows the developer 1401 to define what content 501 is controlled by the widget 403 and what data source 1404 is employed. The custom coding allows the developer to provide custom information and media 1405, interactions 1406, transactions 1407, and collect data 1408 on user 201 activity. The structure features of the widget 403 define the widget programing 907.

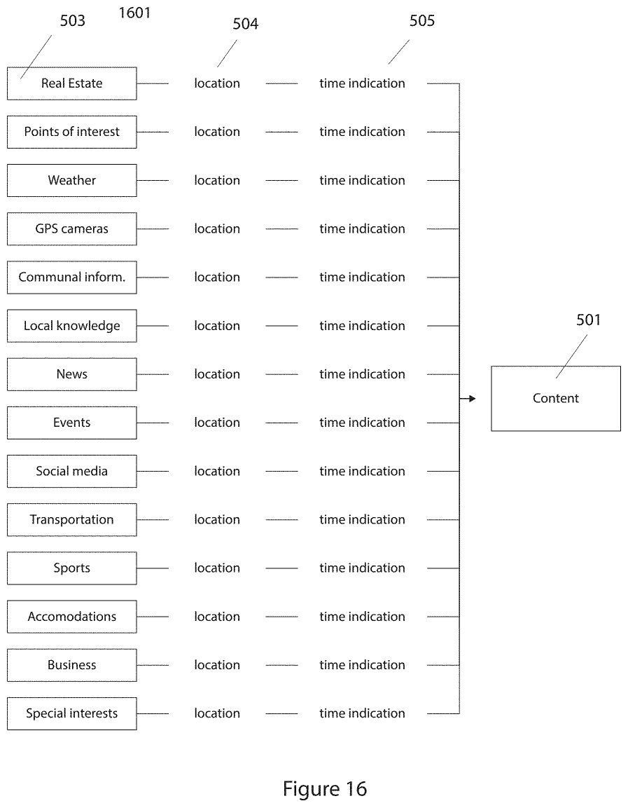

FIG. 16 is a simplified block diagram showing various subject matters 1601 which may represent a map mode 301. Content 501 related to the subject matter 1601 generally comprises a geo location 504 and a time stamp 505. The time stamp 505 indicates when the content 501 occurred. A widget 403 may control whether items of content 501 with a certain time stamp 505 is displayed. A map mode 301 may be employed for each of the respective subject matters 1601. A widget 403 may have widget programing 907 which allows the widget 403 to be used for filtering, sorting, or searching content 501 based on a time stamp 505.

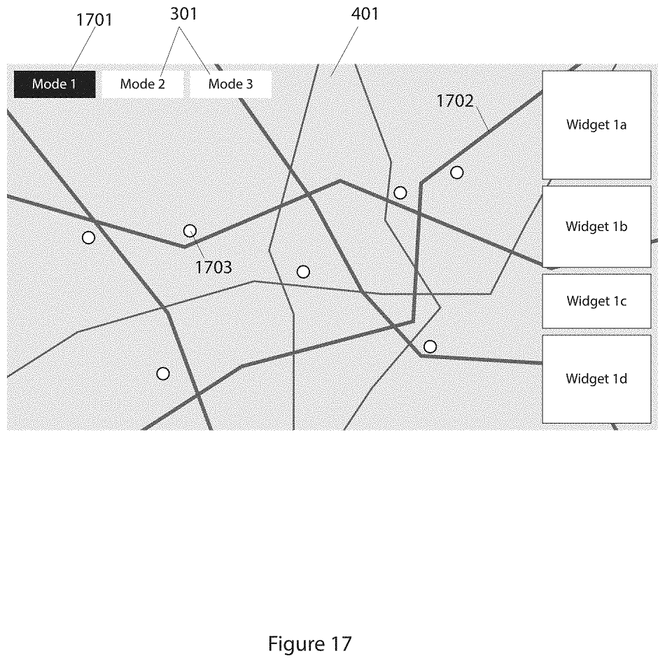

FIG. 17 shows an exemplary map interface wherein content 501 is shown on the map interface 401 based on the map mode 301 selected. Shown in the figure is a map interface 401 wherein the user 201 has selected an exemplary map mode 1 1701. Alternative map modes 301 are shown which the user 201 may select. In this exemplary figure, a variety of roads 1702 are shown as well as a map marker 1703. Roads 1702 and map markers 1703 are examples of content 501. A set of exemplary widgets 403 that are applicable to map mode 1 1701 are displayed which the user 201 may activate.

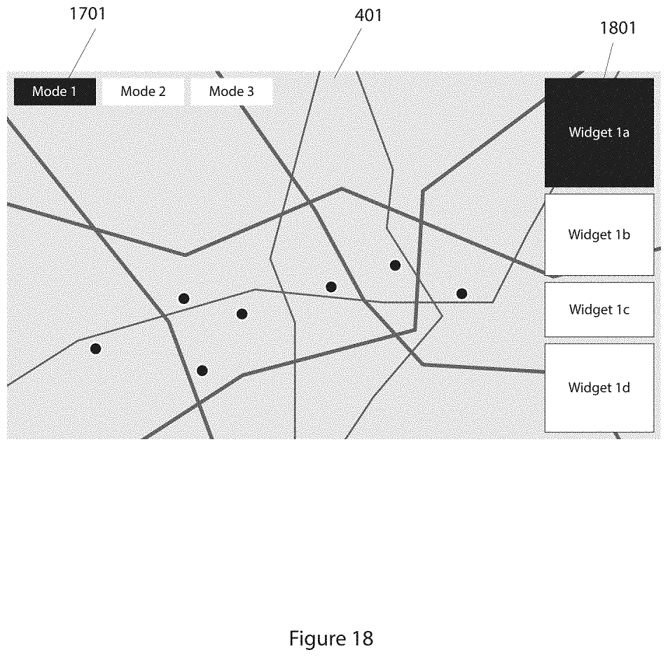

FIG. 18 shows an exemplary map interface 401 wherein content 501 is displayed on the map interface 401 based on the widget 403 activated. Shown in the figure is a map interface 401 wherein the user 201 has selected an exemplary map mode 1 1701 and has activated an exemplary widget 1a 1801. The map interface 401 shows the content 501 as defined by the widget programing 907 of widget 1a 1801.

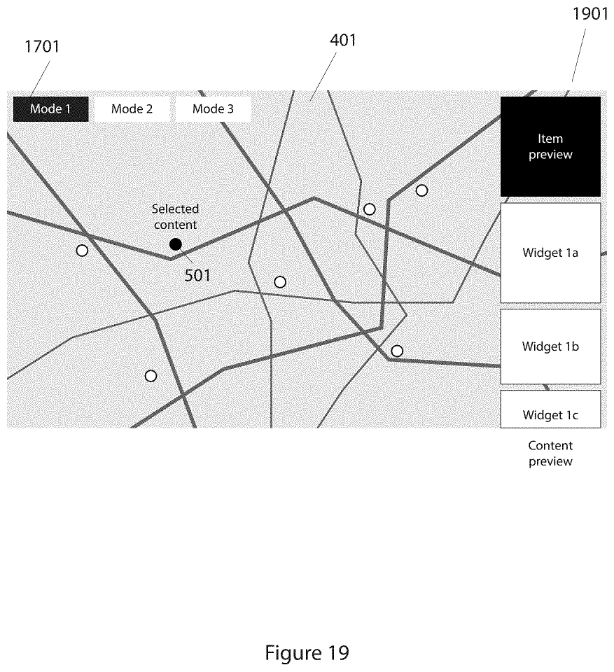

FIG. 19 shows an exemplary map interface 401 wherein a user 201 has selected an item of content 501 which is configured to view content information 904. Shown in the figure is a map interface 401 wherein the user 201 has selected an exemplary map mode 1 1701 and has clicked an item of content 501. An item preview 1901 is shown based on the clicked item of content 501.

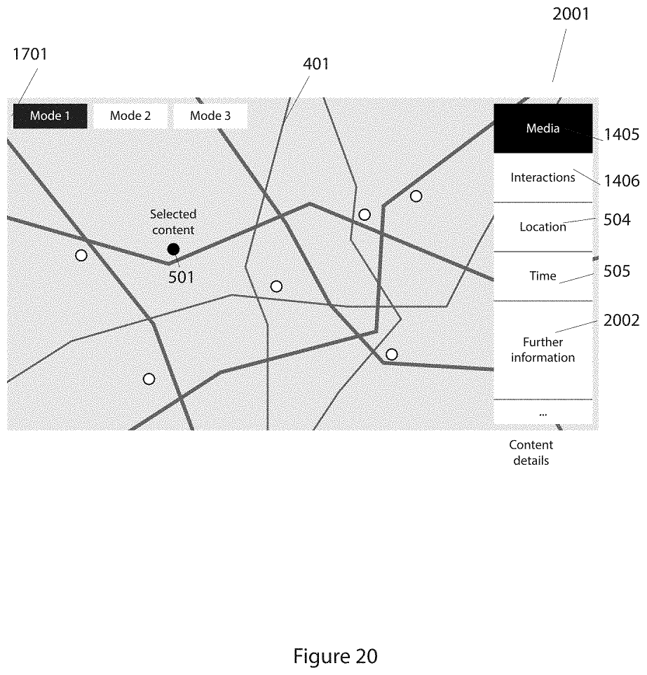

FIG. 20 shows an exemplary map interface 401 wherein a user 201 has clicked an item of content 501 which is configured to view content information 904. Shown in the figure is a map interface 401 wherein the user 201 has selected an exemplary map mode 1 1701 and has clicked an item of content 501. An item detail 2001 is shown based on the clicked item of content 501. In this exemplary embodiment the item detail 2001 is comprised of an interaction 1406, a geo location 504, a time stamp 505, further information 2002, information and media 1405, as well as additional information.

### Explanation of Exemplary Language

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof.

Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A map browsing method comprising of:
using a client computer connected to a computer network;
displaying a map interface to a user on the client computer, the map interface displaying content being provided by one or more servers connected to the computer network, said map interface displaying base map detail; and
selecting a map mode, selecting the map mode activating a widget group, the widget group comprising a widget, the widget causing the map interface to display content, wherein the widget group is comprised of a subject defining the map mode.

2. The map browsing method of claim 1, further comprising the widget group comprising of more than one widget.

3. The map browsing method of claim 1, further comprising the user activating a widget.

4. The map browsing method of claim 1, further comprising the user activating more than one widget.

5. The map browsing method of claim 1, further comprising the user entering a widget library and viewing widgets.

6. The map browsing method of claim 1, further comprising using a time stamp for determining the content be displayed by a widget.

7. The map browsing method of claim 1, further comprising saving a configuration.

8. The map browsing method of claim 1, further comprising using an algorithm for determining what content to be displayed on the map interface.

9. The map browsing method of claim 1, further comprising selecting a map mode which has a subject of real estate.

10. A map browsing system comprising:
a client computer capable of accessing a computer network;
a map interface, the map interface which may be accessed on the client computer, the client computer being connected to the computer network and at least one server, the server being configured to provide content to the map interface such that the map interface may display said content;
a base map detail to be displayed to a user on the map interface; and
a map mode; the map mode being selected by the user, the map mode having a subject matter, the map mode selected shall cause a widget group comprising of a subject to activate, the widget group comprising of a widget, the widget shall cause content to be displayed on the map interface, the content to comprise of a geo location and the subject.

11. The map browsing system of claim 10, further comprising a widget wherein a user can filter, sort, or search content on the map interface.

12. The map browsing system of claim 10, wherein the widget group may comprise of more than one widget.

13. The map browsing system of claim 10, wherein the user can activate more than one widget.

14. The map browsing system of claim 10, further comprising the widget being capable using a time stamp to determine what content is displayed on the map interface.

15. The map browsing system of claim 10, further comprising a configuration that can be saved.

16. The map browsing system of claim 10, further comprising of content which is compiled for display on the map interface using an algorithm.

17. The map browsing system of claim 10, further comprising of a map mode wherein the subject is real estate.

18. The map browsing system of claim 10, further comprising of a developer portal wherein a developer may login for the purpose of creating new widgets.
